(19) United States
(12) Patent Application Publication
(10) Pub. No.: US 2005/0021343 A1
(43) Pub. Date: Jan. 27, 2005

(54) Method and apparatus for highlighting during presentations

(76) Inventor: Julian A.Q. Spencer, Vermillion, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/626,388

(22) Filed: Jul. 24, 2003

(51) Int. Cl. G10L 15/00

(52) U.S. Cl. 704/275

(57) ABSTRACT

A method and apparatus for activating an object for highlighting during a presentation includes recognizing a spoken activation word. An activation link is invoked when the activation word is recognized, and includes an activation action taken. The presentation is prepared by designating a portion for highlighting by association with the activation link, and the activation word. The activation action includes substitution of the designated portion with another object, activating a multimedia object, changing a background color, applying a graphic effect, or the like to the designated portion.

### FIELD OF THE INVENTION

The present invention generally relates to the field of computers. In particular, the present invention relates to the use of voice recognition for highlighting portions of a displayed presentation.

### BACKGROUND OF THE INVENTION

Modem computer-aided presentations are widely recognized as a useful and systematic means of conveying ideas and demonstrative information to groups and individuals. While giving such presentations, presenters often find the need to “point” to certain areas of the screen to draw the attention of the attendees to a particular object, word, or section of the displayed presentation. Pointing can be problematic in that for most pointing applications, particularly those that by necessity occur at a distance, a pointer such as a laser pointer or the like must be used. Such devices can easily be forgotten or may run out of battery power, or otherwise cease to function during the course of a presentation.

Meanwhile advances continue to be made in the voice recognition area and many useful products now exist for, for example, automated voice transcription, and the like. Many voice recognition software products are now available for installation on most personal computers. In addition to voice recognition, text-to-speech or voice synthesis products are available which convert text into audible human speech by applying an algorithm to text strings and producing a synthesized “voice” for output as reading aids and the like.

One such system is described in International Publication WO 99/66493 published from International Application PCT/US99/13886 by Kurzweil and also described in U.S. Pat. No. 6,199,042 B1 also to Kurzweil. Therein, a computer audio reading device is described for highlighting text. Data structures generated from OCR scans of a text image may be used to highlight the image as the text is “read” using positional information. A mouse may be used to point to a location and the closest word based on positional information is then highlighted and computer generated speech is resumed. It should be noted that Kurzweil fails to teach the use of speech recognition and instead relies on text-to-speech conversion to perform computerized reading where highlighting is synchronized therewith. A description of the generalized concept of synchronizing an audio track with highlighted text in a reading aid can be found in U.S. Pat. No. 4,636,173 issued on Jan. 13, 1987 to Mossman. It should be noted that Mossman also fails to teach or suggest speech recognition.

Another system which does employ speech recognition is described in U.S. Pat. No. 6,405,167 B1 issued to Cogliano for an electronic book. The book is configured with fixed display elements such as LEDs corresponding to fixed words. In another embodiment, the “pages” of the book are LCD displays with the words “permanently” positioned thereupon. Several different stories can be provided by changing memory modules. One obvious drawback of the electronic book of Cogliano is the lack of flexibility in that the words and display elements are fixed.

Still, such systems fail to be widely available for application in areas related to giving presentations. Consequently, it would be desirable to apply the capabilities of voice or speech recognition to assist in making presentations more informative and also to allow the presenter a greater degree of options when giving demonstrative presentations using conventional systems such as computers used in conjunction with projection systems.

### SUMMARY OF THE INVENTION

Accordingly, the present invention is directed to a method and apparatus for activating an object for highlighting during a presentation. In this way pointers can be avoided and the presentation may be given with maximum impact.

In accordance with various exemplary embodiments thereof, the method of the present invention includes recognizing an activation word capable of being spoken, for example, into a microphone or the like. The activation word may be associated with the object to be highlighted and an activation link which associates the activation word to the presentation. The activation link associated with the object may be invoked when the activation word is recognized. It should be noted that the activation link also includes an activation action taken when the activation link is invoked. The activation action is associated with the highlighting and may be specified to generate highlighting effects or the like. Modified display data associated with the presentation may then be generated when the activation action is taken. In preparing the presentation for highlighting, a portion of the presentation such as a word, a line of text, a graphical object or the like, may be designated as the object for highlighting by associating the designated portion with the activation link. The activation link may further be designated with the activation word and the activation action to be taken to effect the desired highlighting. It will be appreciated that the activation action may include substitution of the designated portion with another object, activating a multimedia object associated with the designated portion, changing a background color associated with the designated portion, applying a graphic effect to the designated portion such as blinking or the like.

In accordance with other exemplary embodiments, an apparatus is provided for activating an object for highlighting during a presentation and may include a processor, a sound transducer such as microphone or the like, and preferably a memory for storing processor instructions. The processor may be caused thereby to recognize an activation word spoken into the sound transducer, e.g. during the presentation. The activation word may be associated with the object and an activation link which link associates the activation word to the presentation. The activation link associated with the object may be invoked when the activation word is recognized. The activation link includes an activation action which is taken when the activation link is invoked and which may be associated with the highlighting. Modified display data associated with the presentation may be generated when the activation action is taken. It should be noted that the activation action may include substitution of the designated portion with another object, activating a multimedia object associated with the designated portion, changing a background color associated with the designated portion, applying a graphic effect to the designated portion, or the like.

In accordance with an alternative exemplary embodiment, an apparatus is provided for activating an object for highlighting during a presentation including a processor; a voice recognition module for recognizing an activation word spoken, for example, into a sound transducer associated with the voice recognition module, and a memory. The memory may be used for storing instructions which, when run, cause the processor to invoke an activation link associated with the object when the activation word is recognized. The activation link includes an activation action associated with highlighting taken when the activation link is invoked. Modified display data associated with the presentation may then be generated when the activation action is taken. The activation action may include substitution of the designated portion with another object, activating a multimedia object associated with the designated portion, changing a background color associated with the designated portion, applying a graphic effect to the designated portion, or the like.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagram illustrating a conventional presentation scenario;

FIG. 2A is a diagram illustrating an exemplary presentation scenario using voice highlighting in accordance with various exemplary embodiments of the present invention;

FIG. 2B is a diagram illustrating an alternative exemplary voice recognition and highlighting software arrangement in accordance with various exemplary embodiments of the present invention;

FIG. 2C is a diagram illustrating another alternative exemplary voice recognition and highlighting software arrangement in accordance with various exemplary embodiments of the present invention;

FIG. 2D is a diagram illustrating still another alternative exemplary voice recognition and highlighting software arrangement in accordance with various exemplary embodiments of the present invention;

FIG. 3A is a block diagram illustrating several exemplary steps in accordance with various exemplary embodiments of the present invention; and

FIG. 3B is a block diagram illustrating several exemplary steps in accordance with various exemplary embodiments of the present invention.

### DETAILED DESCRIPTION OF THE INVENTION

The present invention provides a method and apparatus for highlighting objects during a presentation using voice commands. Reference will now be made in detail to the presently preferred embodiments of the invention, examples of which are illustrated in the accompanying drawings.

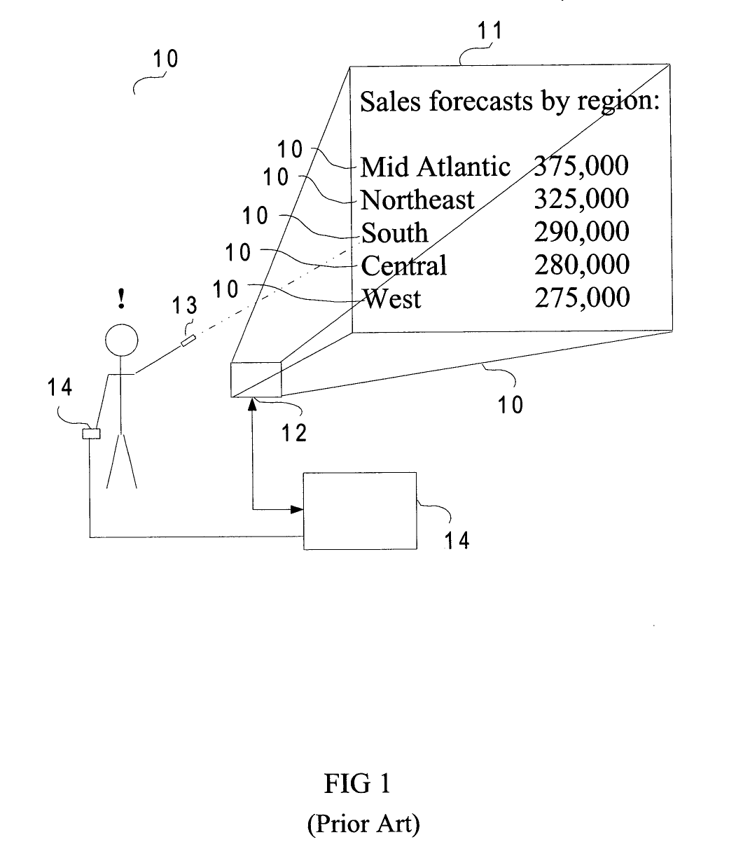

Conventional systems widely used for presentations are generally well known particularly to those who present often. FIG. 1 illustrates conventional presentation scenario 100 where screen 110 of an exemplary visual presentation is being viewed using projection system 120 and being discussed by a presenter. It will be noted that in accordance with conventional methods of highlighting, text or other objects of interest may be emphasized by the presenter during the presentation using pointer 103, typically a laser pointer or the like. As also will be appreciated, the exemplary visual presentation may consist of a presentation developed using a software package such as, for example, Microsoft PowerPoint®, or the like, and may be stored and run using computer 140, which may typically be a laptop computer where presentation screens are advanced using a device such as remote control 141. In conventional presentation scenario 100, highlighting may be accomplished in several ways such as, pointing using a laser pointer as described, or by pre-highlighting areas before the presentation is given resulting in a reduced degree of emphasis at presentation time. It can be appreciated that a superior method of highlighting would include the ability to highlight a designated section of interest as the presentation is being given to achieve maximum impact.

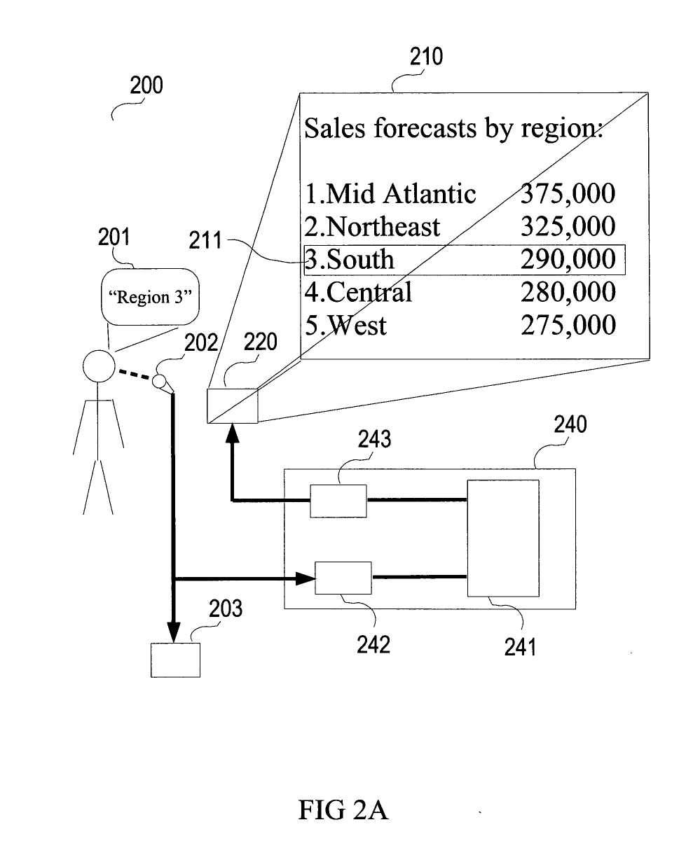

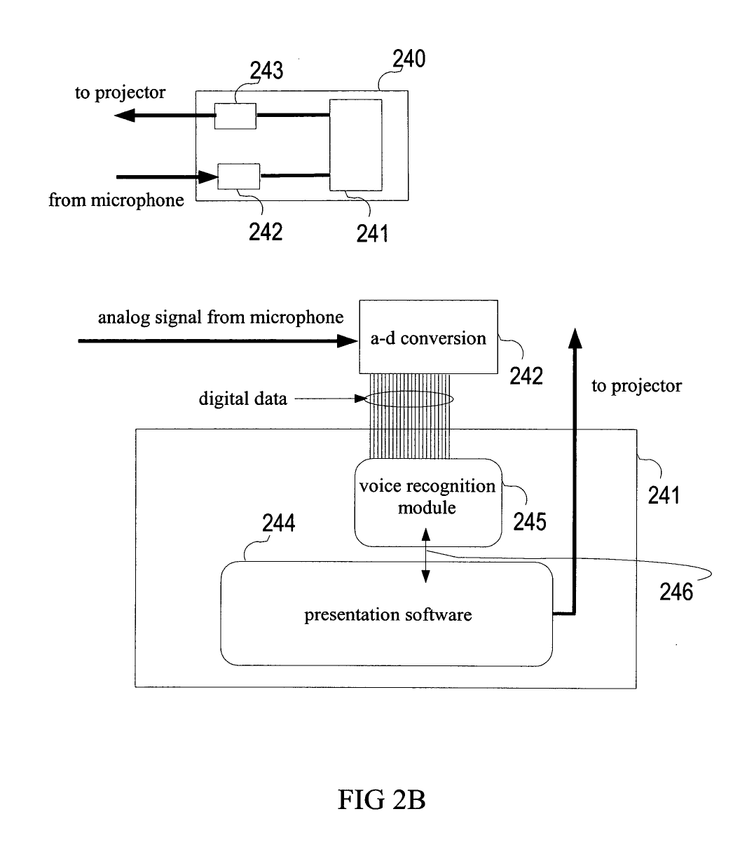

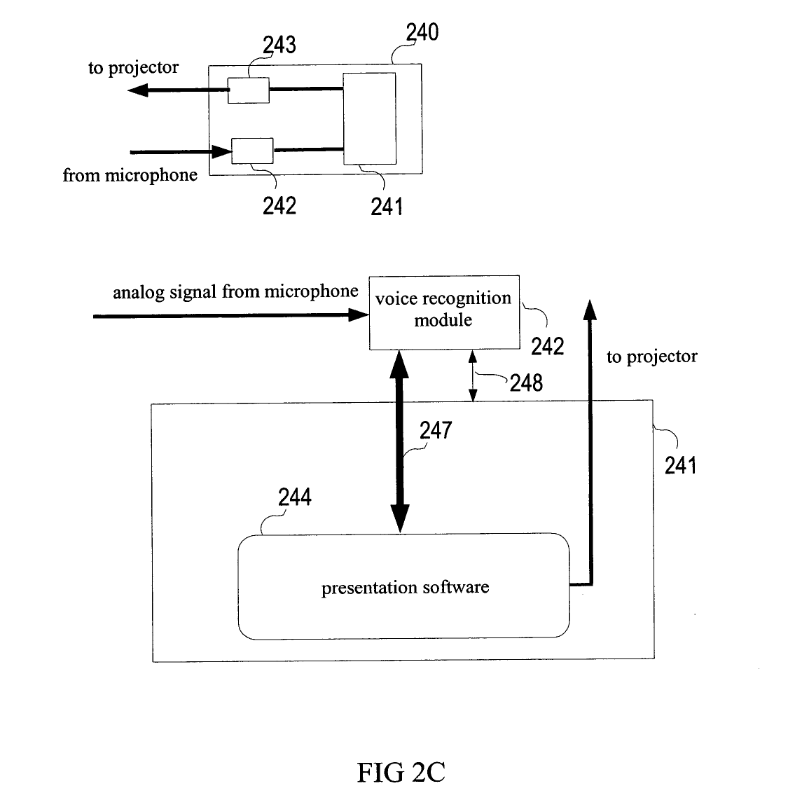

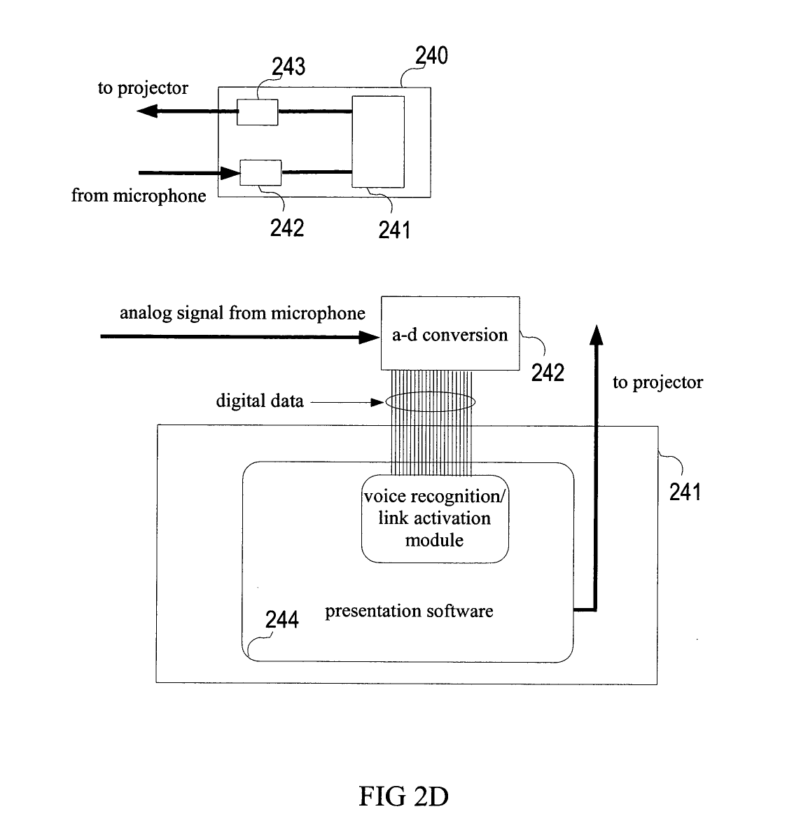

In accordance therefore with various exemplary embodiments of the present invention, FIG. 2A illustrates exemplary presentation scenario 200 including screen 210 of an exemplary visual presentation. Projection system 220 may be any overhead projection system or auxiliary large-screen monitor used to convey information associated with, for example, screen 210 and other screens to a group of attendees while a presenter may discuss information contained therein. It will be noted that computer 240 is preferably a laptop computer but may be any kind of personal computer or general purpose computer capable of running software compatible with the program under which the exemplary presentation associated with screen 210 was created. Accordingly, it will be appreciated by one skilled in the art that computer 240 may be used to run an exemplary program such as, for example, Microsoft PowerPoint®, which would allow the presenter to create and give the exemplary presentation. It will further be appreciated by one skilled in the art that in accordance with various exemplary embodiments of the present invention, the software under which the presentation was created may be modified to create active links, e.g. associative links to objects to be highlighted, which links may be invoked when voice recognition key words are spoken and recognized and which links may contain invocation words and actions to be taken. Alternatively, the software used to create the presentation may further be used to create activation key words and perform attendant voice recognition such that the activation link, activation key word or words, and recognition interrupt may be handled within the same software program or a joint module thereof. If portions of the exemplary software are external to the presentation software, more complex interfacing is necessary to invoke highlighting when key words are recognized.

Regardless of whether activation links and attendant voice recognition software is incorporated within, or located externally to the software running the presentation, highlighting may be accomplished using projection system 220 by recognizing activation key words spoken by a presenter, for example, into microphone 202. In the exemplary scenario illustrated in FIG. 2A, the presenter, for example, may utter phrase 201 containing a spoken reference to “region three” as shown. It can be seen that phrase 201 corresponds to object 211, which in this example is a line of text: “3. South 290,000” such as, for example, would be present in a sales projection. It will be appreciated that object 211 though shown as a line of text could be a single word of text, a graphic object or the like. Moreover, the highlighting action associated with activation could include, for example, a different object, a blinking field or other graphic effect, a multimedia object such as a movie clip or the like. To invoke activation, a voice signal from microphone 202 containing phrase 201 containing the activation keywords, may be processed in module 242, which may be an audio card capable of providing a digital audio signal to central processor 241, may be a general purpose signal processing card capable of performing voice recognition with appropriate software, or may be a dedicated voice recognition card also having appropriate software and software interfaces. Inventor Salah Din's U.S. patent application Ser. No. 09/185,853 filed on Nov. 4, 1998 and assigned to the present assignee involves various aspect of speech and voice recognition, and is incorporated herein by reference in its entirety. As activation links are invoked through recognition of key words associated therewith, a display output signal may be generated wherein the highlighting attributes are sent from the presentation software to output module 243 which may be a display card, a multimedia card or the like for producing an output signal such as a NTSC video signal or RGB video signal capable of being displayed on a monitor, projection screen, or the like.

An exemplary software configuration in accordance with exemplary embodiments of the present invention is shown in FIG. 2B. Analog signals are received from microphone 202, and module 242 is configured as an audio card, or even more simply as an analog-to-digital converter to convert the analog signals to digital signals. In either case, digital data representing voice signals may be transferred on a data bus or channel associated with central processor 241 where presentation software 244 and voice recognition software 245 are running. In the diagram it can be seen that presentation software 244 and voice recognition software 245 are separate programs configured to communicate via inter-process communication channel 246 which may be a messaging interface, a memory mailbox, interrupt vector or the like as would be well-known to one of ordinary skill in the art. Voice recognition software 245 may be configured with software capable of receiving the digital data from module 242, recognizing activation keywords and notifying presentation software 244 which activation links to invoke. Once activated, the highlighted objects may be output to a display device as previously described herein. It should be noted that if module 242 is an audio card capable of generating a digital audio representation of the presenter's voice as spoken into microphone 202, then a software program for performing voice recognition and link activation will preferably be needed resident on central processor 241 or the recognition and link activation capabilities must be incorporated into the software program responsible for creating and giving the presentation.

In the event that module 242 provides recognition capability as shown for example, in FIG. 2C, data signal 247 accompanied, for example, by interrupt 248, may be generated and sent to presentation software 244 running on central processor 241 along with information such as the activation key word that was recognized. It will be noted that data signal 247 is bi-directional allowing activation keywords and/or recognition data associated therewith to be uploaded into module 242, enabling an activation link associated with the activation keyword to be invoked when the activation keyword is recognized. In yet another exemplary software configuration as illustrated in FIG. 2D, voice recognition and link activation may be integrated into presentation software 244. In such an instance, all activity is carried out within presentation software 244 with the exception of digitization of voice signal from microphone 202 by module 242 configured preferably as an audio card with analog-to-digital conversion. As in previous examples, once links are activated, highlighted objects may be displayed on any suitable display device.

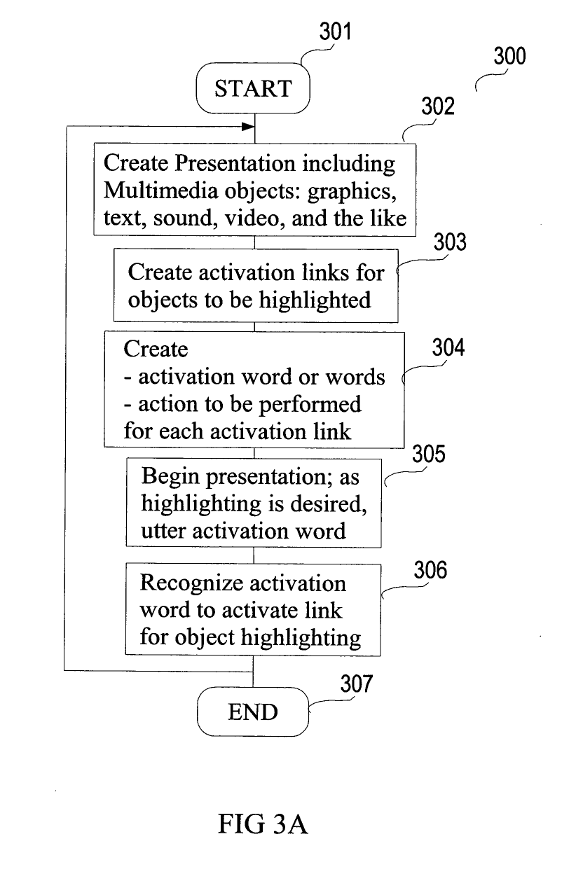

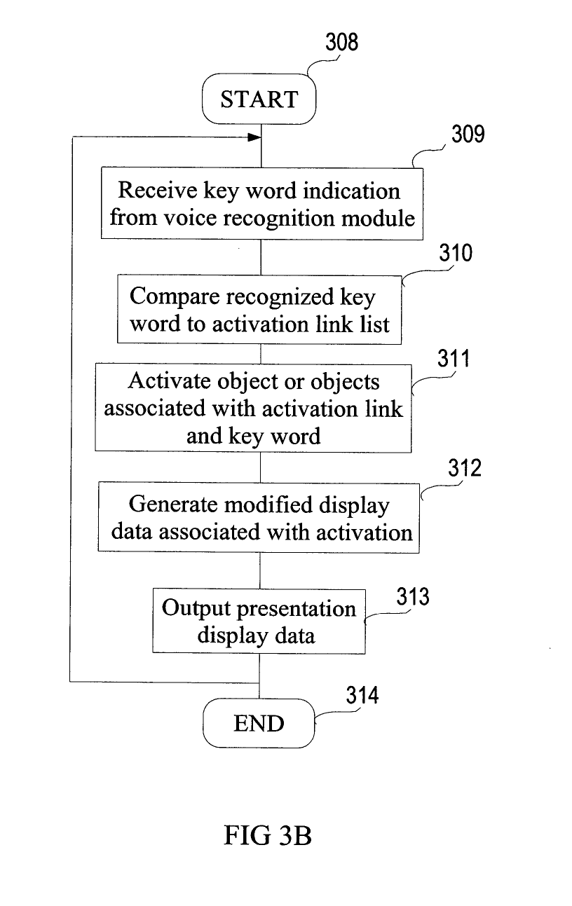

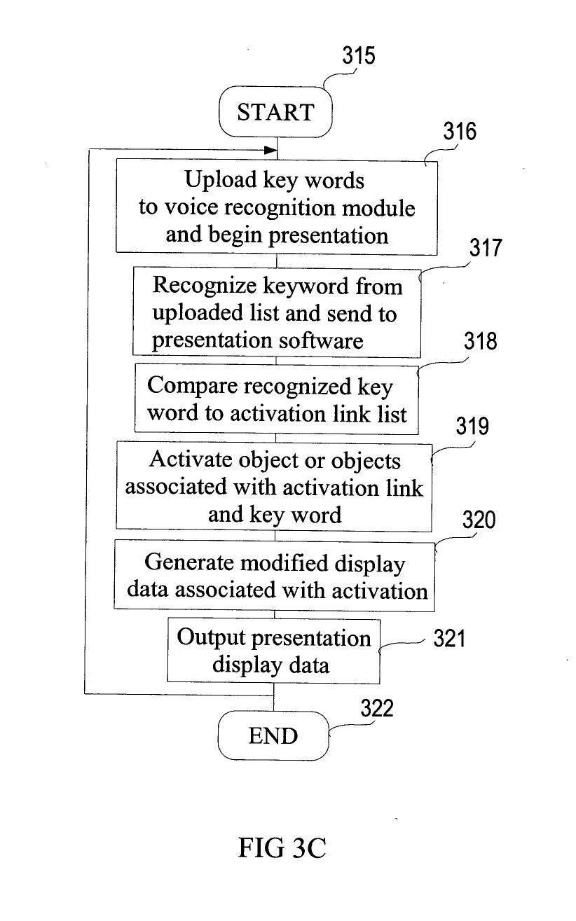

It will be appreciated that in accordance with the method and apparatus of the present invention, steps must be followed to achieve highlighting during presentations as shown in FIG. 3A. At start 301, it can be assumed that the central processor is up and running along with presentation software and modules such as voice recognition modules whether internal software modules or external hardware/software modules. Step 302 includes creating the presentation in the first instance on a suitable presentation package such as, for example, Microsoft PowerPoint®, or the like. A presentation preparer may designate words, lines of text, graphical objects, multimedia objects, or any identifiable portion of the presentation for highlighting. As previously described, the highlighting “action”, e.g. the action to be taken upon activation, may include changing display attributes associated with the designated portion, substituting the portion for a different object, or the like. When the desired portion of the display is designated, an activation link must be created in step 303 whereby a key word or words and action to be taken are specified in step 304. Returning to the example of FIG. 2A, a portion for highlighting preferably includes the line of text: “3. South 290,000”. It will be apparent that other lines of text or even all the lines of text may be designated for highlighting through the creation of an activation link. The keyword association specified is preferably “region three” or simply “three”, and the action is preferably to reverse background field. In other scenarios, it would be possible to specify an action to begin a short multimedia clip associated with region three or the like. During the presentation, keywords may be uttered in step 305, and recognized in step 306 to activate highlighting at which point end 307 is reached until the next sequence.

Referring to FIG. 3B, in an alternative exemplary embodiment with an external voice recognition module, after start 308, an indication along with the word itself may be provided from the voice recognition module to the presenting software in step 309. The recognized key word or activation word may be compared in step 310 with a list of activation words particularly where the external voice recognition module simply transfers any word utterances recognized. The list of activation words may include predefined activation words which are stored in a database or file associated with the presenting software. The recognized word may then be associated with an activation link and the highlighting action specified may then be taken in step 311. Modified display data may then be generated at step 312 and provided either locally at the presentation software application level or alternatively may be directed to a display board for any special display effects that are not within the capabilities of the presentation software package. The modified display data may then be output to a suitable display device in step 313 at which point end 314 is reached until the next sequence. In accordance with still another alternative exemplary embodiment, the external voice recognition module may be more capable and may thus be programmed to carry out additional functions as illustrated in FIG. 3C. Therein after start 315, keywords may be uploaded to the external voice recognition module in step 316 as the presentation is begun. As before, keywords may be uttered by the presenter to activate the desired highlighting. As keywords are recognized in the external voice recognition module from the uploaded list, the word or a coded equivalent along with an indication such as an interrupt or the like, may be provided to presentation software in step 317. Preferably within the presentation software, the recognized key words may be compared in step 318 to a list of activation links to determine the activation link to be invoked and the highlighting action to be taken. The objects are then activated or highlighted according to the specified action in step 319 and the display modified in step 320 as previously described herein. Modified display data may then be output in step 321 to a suitable display device at which point end 322 is reached until the next sequence.

It is believed that the method and apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method for activating an object for highlighting during a presentation, the method comprising the steps of:
recognizing an activation word capable of being spoken, the activation word associated with the object and an activation link;
invoking the activation link associated with the object when the activation word is recognized, wherein the activation link includes an activation action taken when the activation link is invoked the activation action associated with the highlighting; and
generating modified display data associated with the presentation when the activation action is taken.

2. The method of claim 1, further comprising the step of preparing the presentation for highlighting including:
designating a portion of the presentation as the object for highlighting by associating the designated portion with the activation link;
designating the activation word associated with the activation link; and
designating the activation action associated with the activation link and the highlighting.

3. The method of claim 2, wherein the activation action includes substitution of the designated portion with another object.

4. The method claim 2, wherein the activation action includes activating a multimedia object associated with the designated portion.

5. The method of claim 2, wherein the activation action includes changing a background color associated with the designated portion.

6. The method of claim 2, wherein the activation action includes applying a graphic effect to the designated portion.

7. An apparatus for activating an object for highlighting during a presentation, the apparatus comprising:
a processor;
a sound transducer coupled to the processor; and
a memory associated with the processor and the sound transducer, the memory for storing instructions for causing the processor to:
recognize an activation word capable of being spoken into the sound transducer, the activation word associated with the object and an activation link;
invoke the activation link associated with the object when the activation word is recognized, wherein the activation link includes an activation action taken when the activation link is invoked the activation action associated with the highlighting; and
generate modified display data associated with the presentation when the activation action is taken.

8. The apparatus of claim 7, wherein the activation action includes substitution of the designated portion with another object.

9. The apparatus claim 7, wherein the activation action includes activating a multimedia object associated with the designated portion.

10. The apparatus of claim 7, wherein the activation action includes changing a background color associated with the designated portion.

11. The apparatus of claim 2, wherein the activation action includes applying a graphic effect to the designated portion.

12. An apparatus for activating an object for highlighting during a presentation, the apparatus comprising:
a processor;
a voice recognition module coupled to the processor, the voice recognition module for recognizing an activation word capable of being spoken into a sound transducer associated therewith, the activation word associated with the object and an activation link; and
a memory associated with the processor and the voice recognition module, the memory for storing instructions for causing the processor to:
invoke the activation link associated with the object when the activation word is recognized, wherein the activation link includes an activation action taken when the activation link is invoked the activation action associated with the highlighting; and
generate modified display data associated with the presentation when the activation action is taken.

13. The apparatus of claim 12, wherein the activation action includes substitution of the designated portion with another object.

14. The apparatus claim 12, wherein the activation action includes activating a multimedia object associated with the designated portion.

15. The apparatus of claim 12, wherein the activation action includes changing a background color associated with the designated portion.

16. The apparatus of claim 12, wherein the activation action includes applying a graphic effect to the designated portion.
